(19) United States
(12) Patent Application Publication
(10) Pub. No.: US 2003/0004745 A1
(43) Pub. Date: Jan. 2, 2003

(54) Car chart generation computer system

(76) Inventors: Keiji Takakura, Tokyo (JP); Michitada Kameoka, Wako-shi (JP); Masato Honjo, Tokyo (JP)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/125,464

(22) Filed: Apr. 19, 2002

(30) Foreign Application Priority Data
May 11, 2001 (JP) 2001-140932

(51) Int. Cl. G06F 17/60

(52) U.S. Cl. 705/1

(57) ABSTRACT

The convenience of a car chart provided on a Web site on the Internet is improved. A computer system is provided that generates a customer-specific car chart in order to provide a customer-specific car chart page on a Web site on the Internet and includes a data editor for editing data about each customer based on information obtained from an electronic control unit in a car and information obtained when sales is done to generate the car chart and a car chart database for storing the edited customer-specific car chart, wherein a car chart page personalized for each customer is generated. The car chart is generated based on the information obtained from the electronic control unit of the car and the information obtained when sales are made.

### BACKGROUND OF THE INVENTION

1. Field of the Invention

The present invention relates to a computer system for generating a customer-specific car chart (Karte, case record) for adding a customer-specific car chart page in a company Web site on the Internet.

2. Description of the Related Art

It is a common practice for automobile companies to provide personalized Web pages on their Web sites that are personalized for individual customers and can be viewed by the customers through verification of their IDs and passwords respectively. The Web pages contain car charts that indicate the status of the cars owned by individual customers. The customers can activate browsers on personal computers to access the personalized Web pages to view the car charts. A car chart includes a HTML format in which a customer can enter information about his/her car or can update the chart.

The car chart contains items required for maintaining a car, such as the number of miles driven, gas mileage, the date on which engine oil was changed, and a tire wear level. The customer can check the car chart to see if his/her car requires services such as inspection, part replacement, and tune up.

### SUMMARY OF THE INVENTION

However, the conventional car charts are inconvenient in that they require the customers to input a number of items of information. Therefore, it is an object of the present invention to improve user friendliness of the car chart provided on a Web site over the Internet.

According to the present invention, there is provided a computer system for generating a car chart personalized for a customer. The system comprises a data editor for editing data for each customer to produce a car chart based on information obtained from an on-board electronic control unit in a car and information obtained when a sales is done. The system includes a car chart database for storing the edited car chart for each customer. A car chart page personalized for each customer is generated.

According to the present invention, the car chart is generated based on information obtained from the on-board electronic control unit in the car and information obtained when sales is done. The number of items which each customer is required to input is reduced and therefore the convenience of the car chart is improved.

According to one embodiment of the present invention, the computer system comprises a customer comprehension engine for determining the need property of a customer based on factors concerning to the customer. The customer comprehension engine is programmed to output a signal based on information contained in a car chart database. The signal is for prompting an action of starting working on the customer.

According to another embodiment of the present invention, the customer comprehension engine is configured to select a working-on-a-customer content according to the service need property of the customer if the car chart contains an item indicating that the car requires a service.

According to yet another embodiment of the present invention, the data editor edits car charts for sales/service stores in addition to car charts for the customers. This allows sales stores to provide customer-sensitive services based on information about individual customer cars and about the customers.

According to another embodiment of the present invention, data in an electronic control unit is transferred from a car to a computer or a terminal device at a service shop by wireless transmission or through a memory card when the car is brought to the service shop. This allows detailed data on the status of the car to be taken into the system without keyboard entry by the customer.

### BRIEF DESCRIPTION OF THE DRAWINGS

FIG. 1 shows a block diagram of a general configuration of a system according to one embodiment of the present invention.

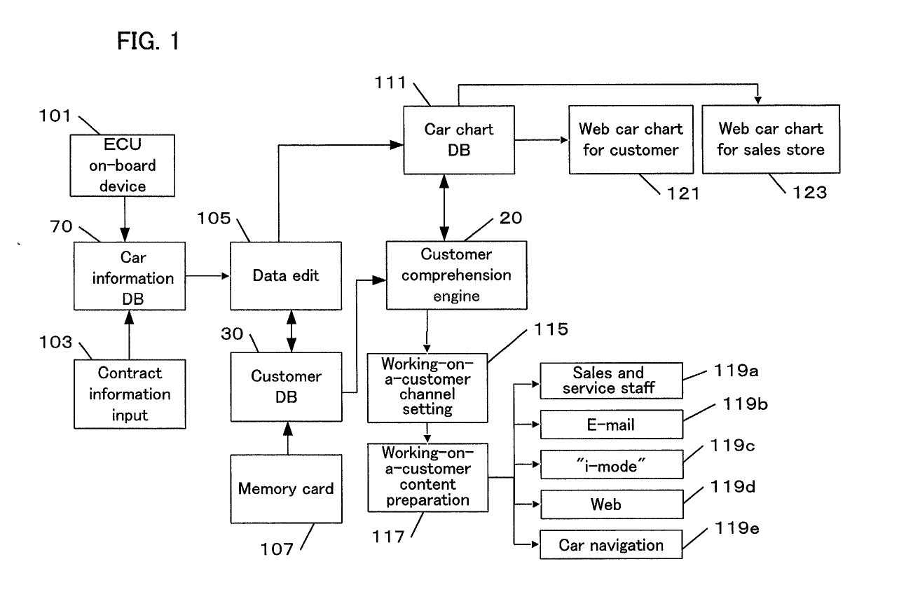

FIG. 2 shows a flowchart of general process flow according to one embodiment of the present invention.

FIG. 3 shows a flowchart continued from the flowchart shown in FIG. 2.

FIG. 4 shows an exemplary car chart screen according to one embodiment of the present invention.

FIG. 5 shows a block diagram of a general configuration of one embodiment of a sales support system on which the present invention is based.

FIG. 6 shows a flowchart of a general process flow in the sales support system shown in FIG. 5.

FIG. 7 shows a flowchart of a general process flow for calculating rank variables in the sales support system shown in FIG. 5.

FIG. 8 shows exemplary factors for identifying need property.

FIG. 9 is a diagram showing classification of use identification information according to one embodiment of the present invention.

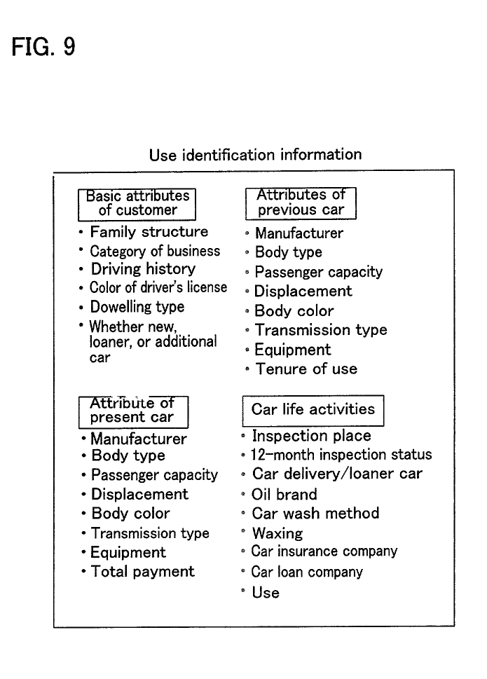

FIG. 10 shows an example of the calculation of rank variables according to one embodiment of the present invention.

FIG. 11 is a flowchart of a process of working-on-a-customer determination process according to one embodiment of the present invention.

FIG. 12 show an example of the calculation of a content browse influence value according to one embodiment of the present invention.

FIG. 13 shows exemplary content browse influence values and working-on-a-customer determination reference values according to one embodiment of the present embodiments.

FIG. 14 is a block diagram of a process for generating working-on-a-customer contents according to one embodiment of the present invention.

FIG. 15 shows the process of generating a message for working-on-a-customer according to one embodiment of the present invention.

FIG. 16 shows a flow of a working-on-a-customer process according to one embodiment of the present invention.

FIG. 17 shows a flow of a database update process based on the results of the working-on-a-customer according to one embodiment of the present invention.

FIG. 18 shows a method for calculating a factor for correcting an influence value in accordance with reception transaction results according to the one embodiment of the present invention.

FIG. 19 shows another example of factors for identifying a customer having a need potentially responsive to working-on-a-customer.

FIG. 20 shows yet another example of factors for identifying a customer having a need potentially responsive to working-on-a-customer.

FIG. 21 is a flowchart of a process flow of discriminant analysis.

### DETAILED DESCRIPTION OF THE PREFERRED EMBODIMENTS

An embodiment of the present invention will be described below with reference to the accompanying drawings. When an automobile is brought to a sales store (or service shop) for maintenance or other purposes, information about the parts and the status of the automobile (hereinafter called “on-board data”), which can be obtained from an on-board device 101 such as an electronic control unit (ECU) installed in the automobile, is transmitted from a wireless device connected to the on-board device 101 to a receiver at a sales store and is entered into a terminal device at the sales store. The on-board data is then transferred from the terminal device to a car information database 70 at a center.

The on-board data may be read into the terminal device through a memory card, instead of the wireless transmission. In that case, a slot into which the memory card is inserted is provided in the automobile to allow the on-board data to be loaded from the on-board device into the memory card. A slot for receiving a memory card is also provided in the sales store terminal device, allowing the information on the memory card to be read into the terminal device.

If a sales contract for the automobile is signed, data about the automobile is input and stored in the on-board data database 70 through an input device 103 such as the terminal device at the sales store. If driver's licenses are issued in the future in the form of memory cards such as IC cards, it will become possible to read information from the memory cards 107 by the terminal device and store it in a customer database 30.

A data editor 105 reads information on each customer from the car information database 70 and the customer database 30. The editor 105 edits car charts for individual customers and car charts for the sales stores. The car charts thus generated are stored in a car chart database 111. When the customer accesses a Web site provided by this system and enters into its personalized page through verification of its ID and password, the car chart 121 created for the customer is sent to the customer's browser for display. Similarly, when a staff member of the sales store accesses the Web site, a car chart for sales store relating to a customer served by the sales store is sent to sales store's browser for display.

A customer comprehension engine 20 constitutes a part of a sales support system, which will be described hereafter. The engine 20 determines through a statistical analysis the need property of the customers based on various factors. If the engine 20 determines, based on information contained in the customer database 30 and the car chart database 111, that a customer should be worked on, it sends a signal for activating a working-on-a-customer process to a working-on-a-customer channel setting unit 115. In response, the channel setting unit 115 sets a channel for working-on-a-customer. A content preparation unit 117 prepares content for the working-on-a-customer. Once the content is prepared, one of a sales and service staff channel 119a, e-mail channel 119b, “i-mode (mobile phone)” channel 119c, Web channel 119d, and car navigation system channel 119e is selected according to the preference of the customer which was analyzed in advance. The customer is worked on via the selected channel. If for example e-mail is set as a default channel and the customer's favorite channel has not been determined through analysis, the working-on-a-customer is provided by e-mail.

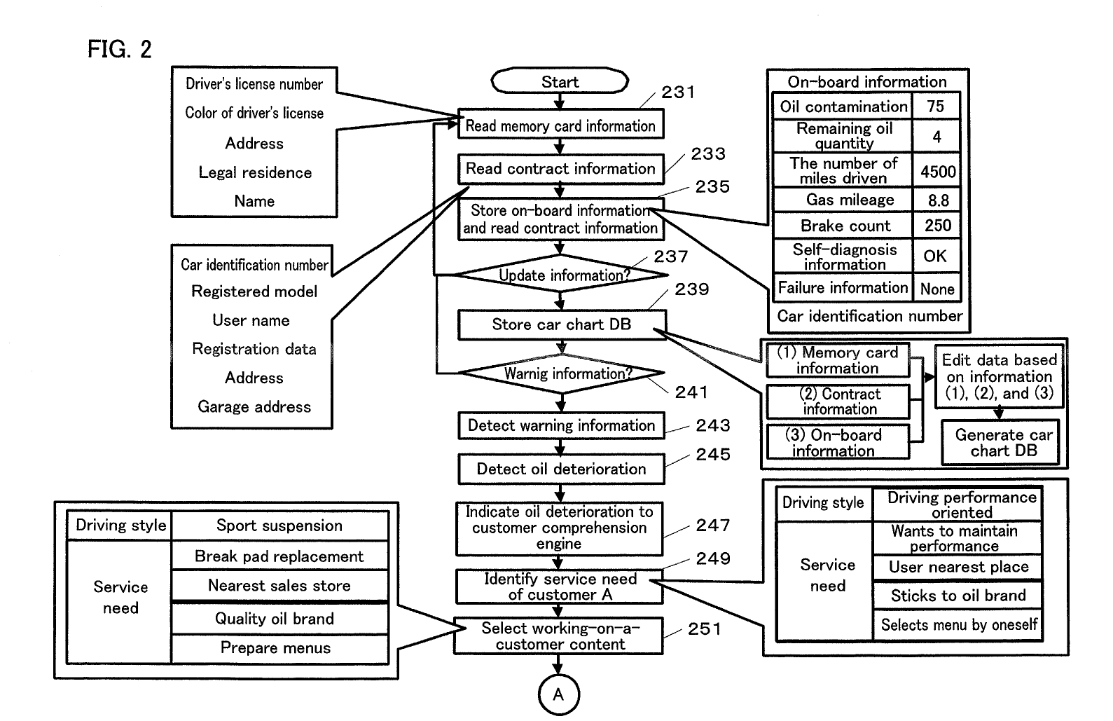

FIG. 2 shows a flowchart of a process flow according to an embodiment of the present invention. If a driver's license is available in a memory card form, information is read from the card (231). Information, including the one obtained when sales is done, such as a car identification number, registered model name, user name, registration date, and place of garage, is read into the system and is stored in the car information database 70. The on-board data obtained from the on-board device and stored in the car information database 70 as described above includes, for example, values indicating oil contamination level, remaining oil quantity, the number of miles driven, gas mileage, the number of times the brake is applied per unit time, self diagnosis of the ECU, and failure information.

If the information is updated (237), the car chart database 111 and a corresponding car chart are updated. If warning information about oil deterioration is added to the car chart through an editing of new data for example (243), that information is provided to the customer comprehension engine 20. The engine 20 identifies the service need property of customer A to whom the warning is to be provided, based on data stored in the customer database 30. A service need is the property of customer's demand for services and includes, for example, the level of demand for maintaining the performance of its car and the level of demand for obtaining services for the car in a place nearest to the customer.

Based on identified service needs, content for working-on-a-customer to be provided to the customer is selected (251). For example, if the customer has a strong need for obtaining services in the nearest place, the name of a sales store nearest the customer is included in the content. If the customer has a strong need for high-efficiency oil, the brand name of high-efficiency oil is included in the content.

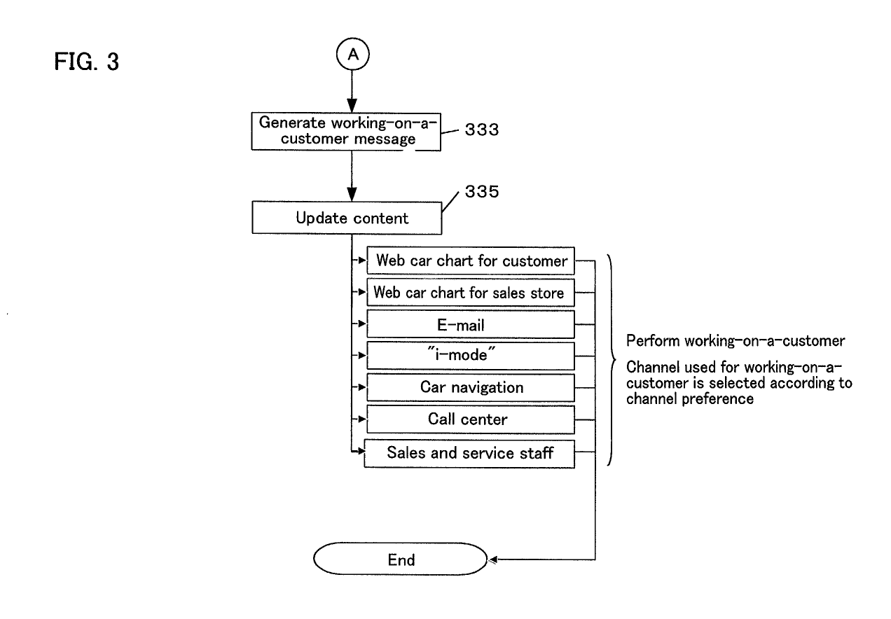

The process proceeds to block 333 in FIG. 3, where a working-on-a-customer message is generated and the content to be provided to the customer is updated (335). The content thus prepared is provided to the customer over a channel selected according to customer's channel preference. In the example shown, a working-on-a-customer channel that is most likely to be preferred by the customer is selected from a group of channels including Web car charts for customers, Web car charts for sales stores, e-mail, “i-mode”, car navigation systems, a call center, and sales/service staff.

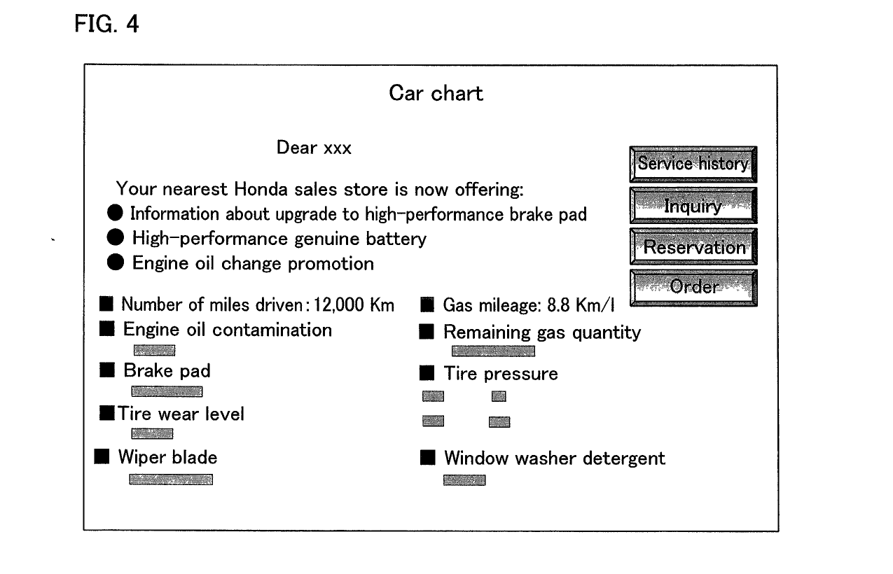

FIG. 4 shows an exemplary car chart screen according to an embodiment of the present invention. In this car chart, the number of miles driven and gas mileage are indicated by numeric values and the status of engine oil contamination, remaining gasoline quantity, air filter, brake pad, tire pressure, battery, tire wear level, wiper blade, and window washer detergent is indicated by color bars.

Unpublished Japanese patent application No. 2000-396577 assigned to the same assignee as the present application relates to a sales support system that stores and manages information about customers. The present invention is based on such a sales support system. The system comprises a customer database for storing data about the basic attributes of a customer, including factors for understanding the customer in terms of car purchase, a Web site that provides company Web pages on the Internet, a Web activity history database for storing Web activity history of each customer based on a log information of access to the company Web pages. The system includes a customer comprehension engine for analyzing the need property of the customer based on the data contained in the customer database to determine the timing of working on a customer based on the Web activity history.

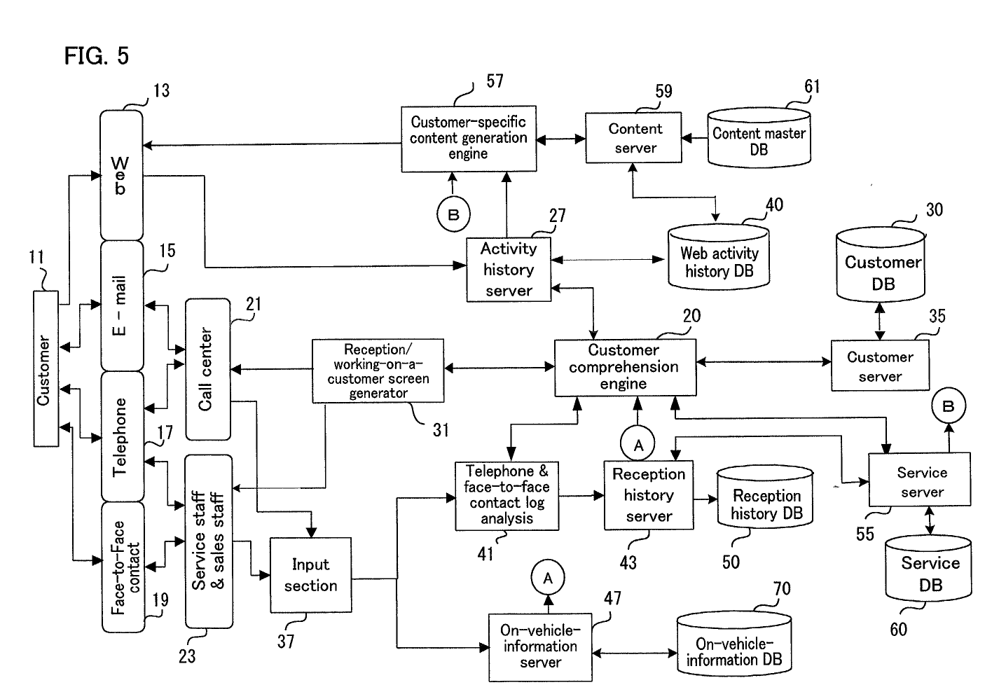

FIG. 5 shows a block diagram of a general configuration of an embodiment of the sales support system on which the system of the present invention is based. An interface between a customer 11 and ABC Company may be the Web site 13 of ABC Company, e-mail 15, telephone 17, or face-to-face contact 19 between the customer 11 and sales and service staff of the ABC Company.

The Web site of ABC Company includes pages that anyone can browse without an ID and a password as well as those pages that registered users can browse through verification of IDs and passwords registered with ABC Company. Each user enters in a sign-up form on the Web page information such as his/her name, age, sex, family structure, dwelling type, annual income, information about his/her car, car life stage, use of the car, hobbies, and driving style.

A server CGI program on the Web site 13 checks the filled sign-up form. If all requisite entries are entered, the CGI program accepts the registration and stores the ID and password for the user in a database. The personal data about the prospective purchaser obtained in this way is transferred from the database of the Web site to a customer database 30 and is stored in it.

The pages that can be browsed after the verification of the ID and password (called “login”) contain detailed information about products of ABC Company in a hierarchical structure. Each of the pages is called content. Related contents are linked together in one or two directions. Selecting and clicking a given item on a menu screen typically displays the top page of the item. When one of a number of items contained in the top page is clicked, a page at the next level is displayed. When one of items contained in the page is clicked, a page at the next level is displayed. As the user goes down through the hierarchy in this way, he/she can access more detailed information.

The customer can browse a personalized Web page, which is specially edited for the customer, through verification of his/her ID and password. The car chart according to the present invention is contained in such a personalized Web page.

An activity history server 27 detects a login by a customer and keeps a log of activities concerning the contents accessed by each customer. The log is stored in a Web activity history database 40. The activity history contains information about browsing of each content, including the number of times the user accessed the content, access frequency, access time, click count, and logout time, as well as content transition information, e-mail transaction information, and the rate of induction from e-mail.

The contents of the Web page are stored in a content master database 61, retrieved by a content server 59, and sent to the customer. As apparent from description provided hereafter, a customer-specific-content generation engine 57 can generate contents that are personalized for each customer and can send it to the customer based on computation by the customer comprehension engine 20.

The system shown in FIG. 5 provides a distributed database system as a whole. The customer comprehension engine 20 can access the Web activity history database 40 managed by the activity history server 27, the customer database 30 managed by a customer server 35, a reception history database 50 managed by a reception history server 43, a service database 60 managed by a service server, and a on-vehicle-information database 70 managed by a on-vehicle-information server 47. The comprehension engine 20 may retrieve data from these databases.

Stored in the customer database 30 are customer numbers unique to individual customers, vehicle identification numbers of the cars that are produced by ABC Company and are owned by customers, codes of sales centers and service centers that serve individual customers, and basic attributes of the customers that are input by the customers in the registration process with the Web site.

The reception history server 43 stores reception log concerning each customer in the reception history database 50 based on the results of customer reception, which are input into an input unit 37 by a call center 21 as well as by service staff and sales staff 23. The information may include a reception staff ID, reception date and time, the purpose and description of the reception, reception time, results of reception, expected next reception date and time, the purpose of the next reception. In addition, a record of working-on-a-customer by ABC Company is stored in the reception history database 50. The record may include working-on-a-customer staff IDs, working-on-a-customer date and time, working-on-a-customer period, the description of the working-on-a-customer, and results from the working-on-a-customer.

In response to input of service data by service staff, the reception history server 43 stores service data in the service database 60 via a service server 55. The service data include for each customer such information as service staff IDs, car entry date and time at a repair shop, purpose of car entry, inspection and service information, information on substitution car rent, information on car take back, working hours, description of service provided, and invoice information.

The on-vehicle-information server 47 stores data downloaded from an on-vehicle electronic control unit (ECU) into the on-vehicle-information database 70. The database contains for each customer a vehicle identification number (VIN) and driving history information on such items as a daily travel distance, gas mileage, oil contamination, speed, accelerator, brake, lockup, handbrake, blinkers (winker), gasoline gauge, and trouble diagnosis.

The customer comprehension engine 20 calculates needs property of the customers of each customer according to an algorithm, which will be described later, and determines the timing of working-on-a-customer, and generates a message for working-on-a-customer. The result of the calculation by the customer comprehension engine 20 is sent through the activity history server 27 to the customer-specific content generation engine 57. The engine 57 responds to this by generating contents that meet the needs property of the customers of a customer who needs to be worked on. The contents are generated referencing the Web activity history database and the content master database through the content server 59.

An electronic file of contents may be sent by e-mail to the customer to be worked on. When the electronic file is opened on a personal computer of the customer, the browser is activated to allow the file to be browsed. In another embodiment, instead of sending the electronic file directly to the customer of interest, an e-mail message is sent to the customer for notifying that contents specialized for the customer are provided on the Web page and working on the customer to view the content. The URL of the specialized contents is linked to the e-mail message. When the customer receives the e-mail message, he/she can browse the specialized contents by clicking the URL contained in the e-mail message to visit the Web site of ABC Company.

In yet another embodiment, the results of the calculation by the customer comprehension engine 20 are formed as display frames in the reception/working-on-a-customer screen generator 31 and are sent to the sale staff section 23. A member of the sales staff views the screen on a terminal device and contacts the customer of interest according to the information and instructions available on the screen.

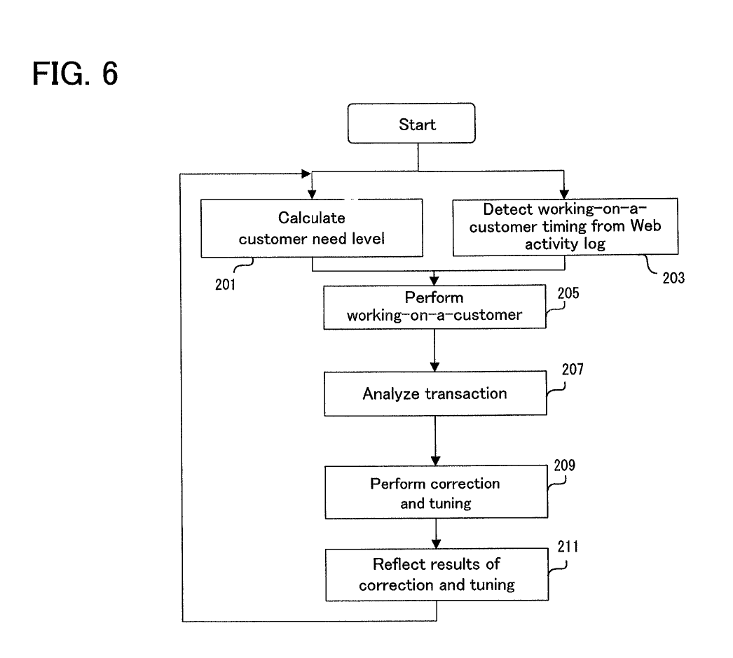

FIG. 6 shows a general flow of a program executed by the customer comprehension engine 20. A need level of a given customer is calculated (201) according to an algorithm. The timing of working on a given customer is detected (203) according to an algorithm. Working-on-a-customer that matches the property of the needs of the customer is performed at the timing thus detected (205). A transaction resulting from the working-on-a-customer is analyzed (207). Variables and factors included in the need level calculation algorithm and the working-on-a-customer timing detection algorithm are corrected and tuned based on the results of the analysis (209). The results of the correction and tuning are reflected in the algorithms (211). Thus, the program evolves.

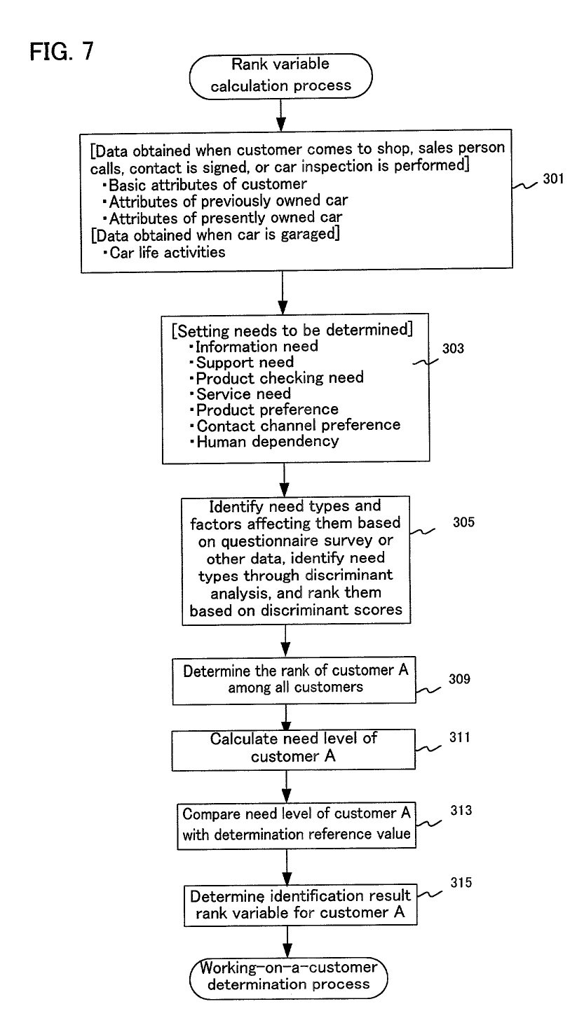

FIG. 7 shows a process for calculating rank variables that indicates needs level of a given customer. Data such as the basic attributes of the customer, attributes of a car previously owned by the customer, attributes of a car presently owned by the customer, and information on-board life activities are stored in the various databases described with reference to FIG. 5 (301). The data are classified into a basic factor set and a plurality of extended factor sets. Combination of the basic factor set and extended factor sets is used to identify the needs property of the customers.

In one embodiment, the basic factor set is provided for all target customers and includes factors provided in Table 1.

TABLE 1
Basic factor set

Factors obtained from a contract document
Name Sex Age Presently owned car Car insurance
Unsettled bill
Factors obtained from questionnaires filled in when sales are
done
Family Profession Driving history

Factors obtained from the system.

In this embodiment, the extended factors are classified into extended factor set 1, extended factor set 2, and extended factor set 3. Extended factor set 1 is for target customers who previously owned cars. Extended factor set 2 is for target customers who entered cars in service shops that are not made by ABC Company and customers who own cars made by ABC Company. Extended factor set 3 is for target customers who filled in these items in questionnaires when sales are done. Table 2 provides examples of these factors. In another embodiment, the extended factor set 3 is included in the basic factor set.

TABLE 2

Extended factor set 1
Factors obtained from the system and questionnaires filled
in when sales are done
Previously owned car
Extended factor set 2
Factors obtained from questionnaires filled in when sales are
done or when cars are entered into service shops
Place of compulsory car inspection 12-month inspection
status Place of 12-month inspection Car delivery
Substitution-board rent Place of oil change place
Frequency of oil change Oil brand Frequency of car wash
Method of car wash
Extended factor set 3
Factors obtained from a questionnaire filled in when the
contract is signed
Annual income Annual household income

The customer needs include the items shown in block 303 in FIG. 7. Each need type is discriminated based on a predetermined combination model of the basic factor set and the extended factor set, and its ranking is determined (305).

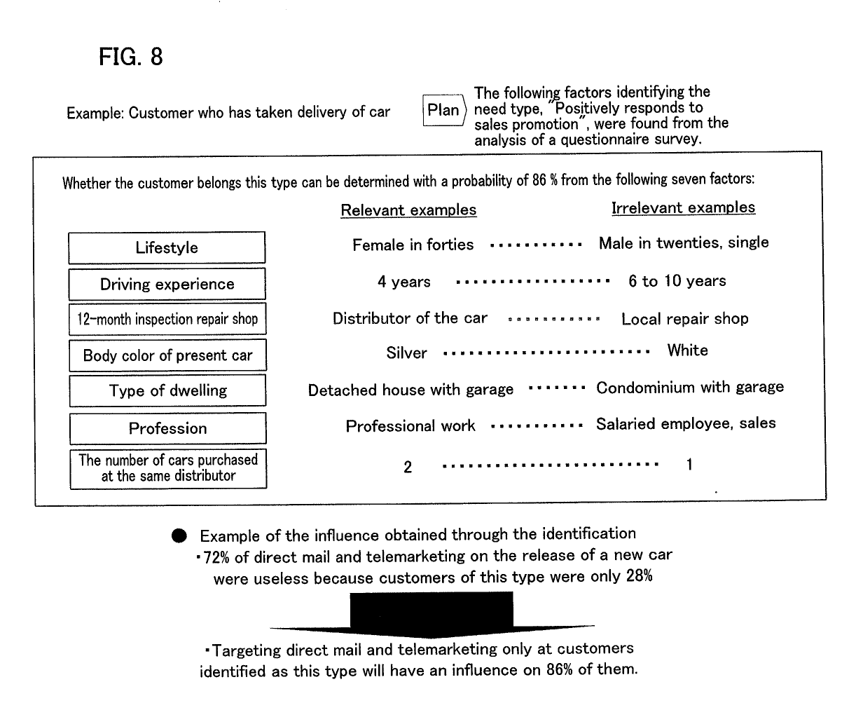

FIG. 8 shows factors for identifying a need type, “a customer who actively responds to sales activities (dependency on person need)”, obtained from the analysis of questionnaire survey. These factors and discriminant analysis approach are used to determine the need type of a customer. Data about individual customers are substituted into a discriminant function to obtain values, that is, discriminant scores, and the data in a set of data are placed in the order of the discriminant scores (305). The ranking of each customer is determined at step 309.

Assume that customer A has registered himself on the Web site of ABC Company. Factors that affect each of the above-mentioned needs are retrieved from data about customer A which is stored in the databases described earlier to identify the needs of customer A. Customer A's ranking in the data set is determined (309).

For example, information need of customer A is one hundred fifty thousandth in the total number of customers of one million two hundred thousand. The rank of each need is converted into percentage to the population parameter (the total number of customers) of the data set. The need level is a rank or order in percent in the total number of customers, the smaller the value, the higher the need level is.

The need level of each of the five need types calculated in this way is classified into five ranks or classes 1 to 5 based on a determination reference value (313). Rank 1 represents the most significant influence. The larger the rank value, the smaller the influence is.

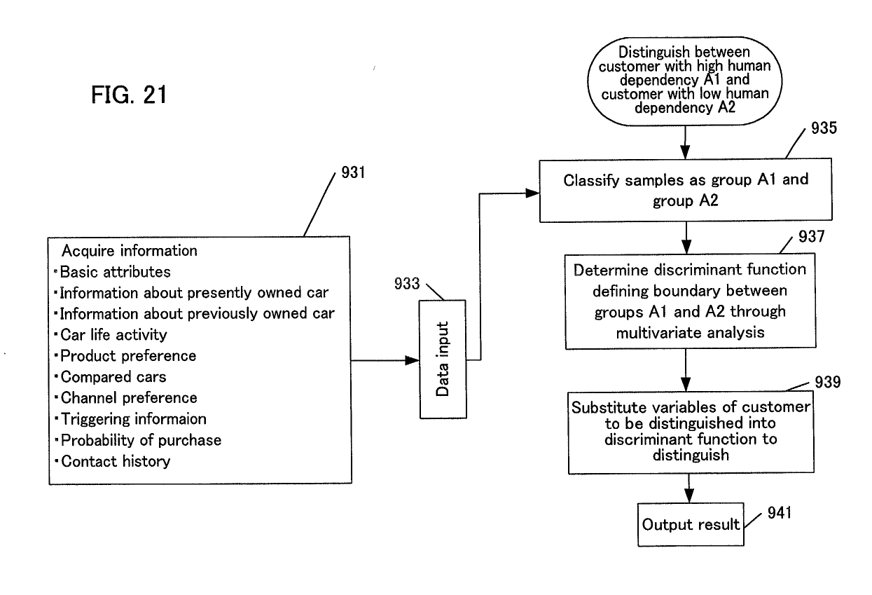

FIG. 21 shows the process flow of the discriminant analysis. The discriminant analysis itself is a well-known method and therefore the detailed description will not be made here. Discrimination can be made using a linear discriminant function that separates two groups with a single straight line or using Mahalanobis distance that separates two groups with a quadric curve.

The example shown in FIG. 21 distinguishes customers between those A1 having higher human dependency, and those A2 having lower human dependency. Data on a large number of samples (931) obtained from questionnaire survey and other sources are input to the system (933). The samples are divided into group A1 and group A2 (935). A statistical analysis is used to determine a discriminant function that defines a boundary between group A1 and group A2 (937). Once the discriminant function is determined, each data value corresponding to each customer is determined as to which side of the discriminant boundary (discriminant curve) it belongs to (939). Thus, customers are classified into two groups. In addition to merely determining which group a customer belongs to, ranking of each customer in a group can be determined according to a discriminant score, which can be obtained by entering the variables of the customer into the discriminant function.

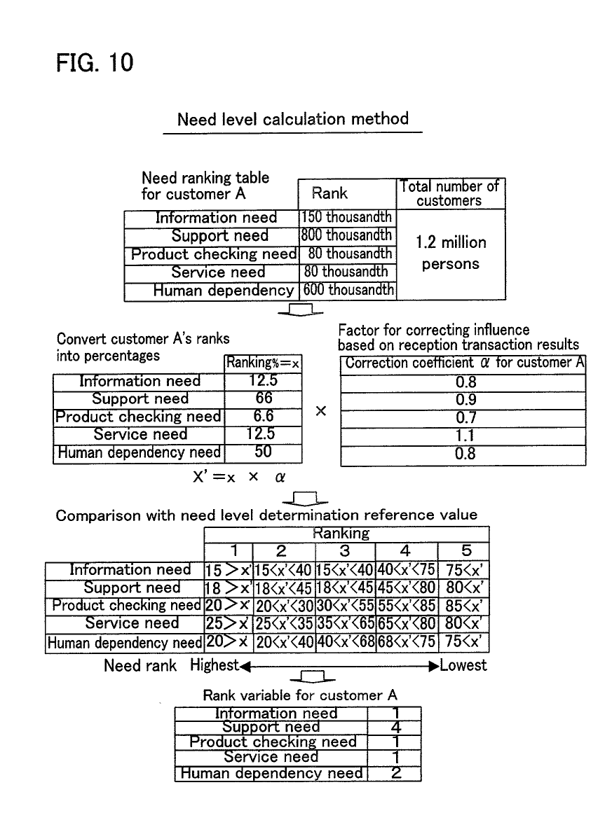

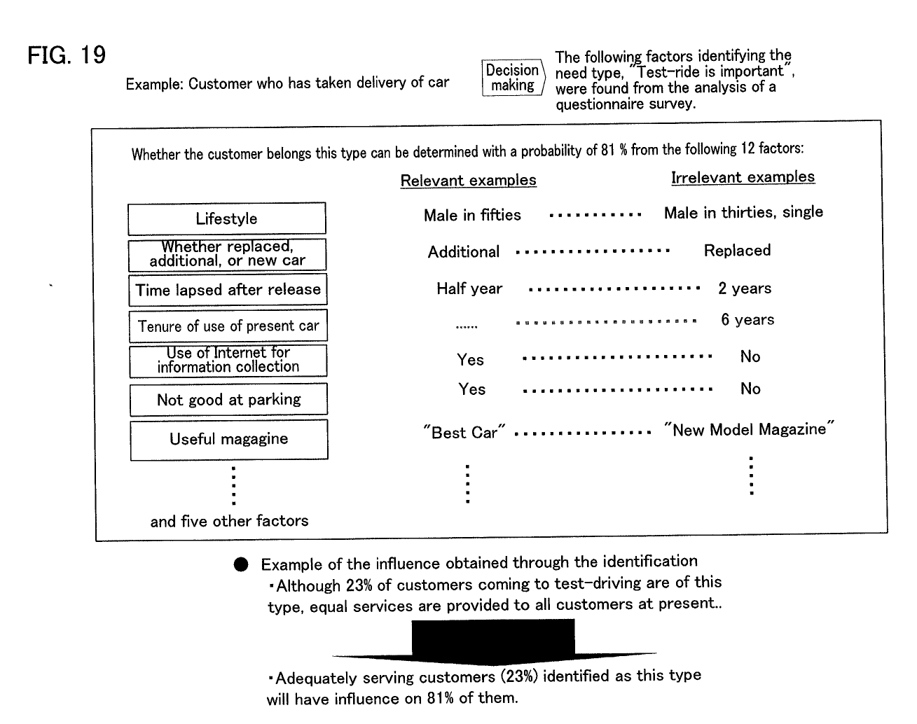

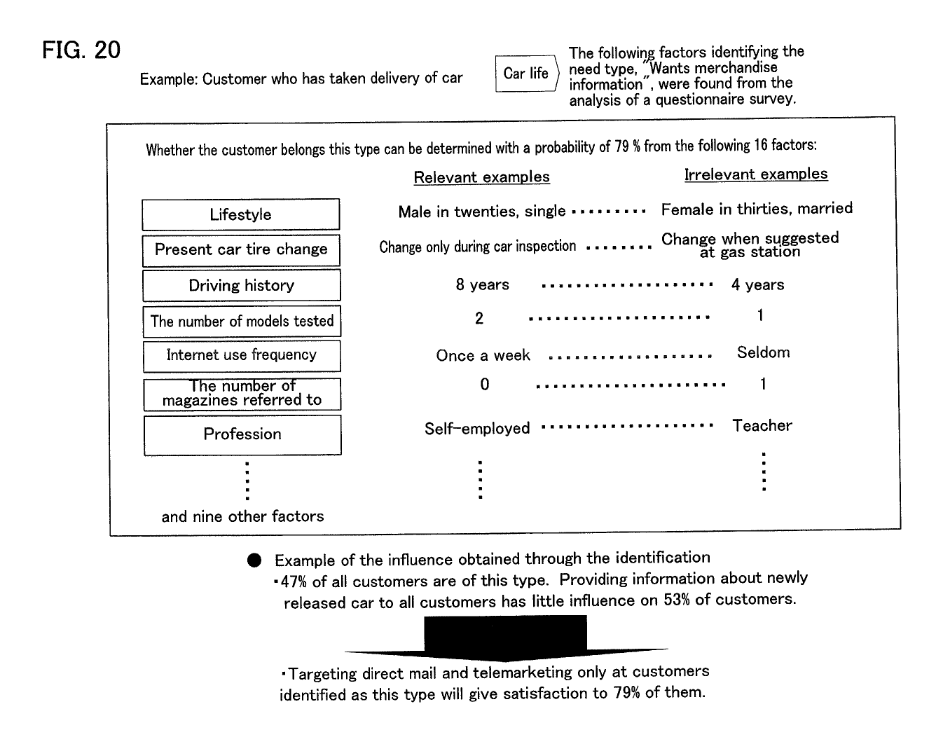

FIG. 8 shows factors for identifying a need type, “a customer who positively responds to sales activities (human dependency need)”, which is obtained from analysis of questionnaires. FIG. 19 shows factors for identifying a need type, “a customer to whom a test ride is important (product checking need)”, which is obtained from the analysis of questionnaires. FIG. 20 shows a need type, “a customer who wants merchandise information (information need)”, which is also obtained from the analysis of the questionnaires. These factors and the discriminant analysis scheme are used to identify need types. Ranking is performed based on a value, that is, a discriminant score obtained by entering data on each customer into the discriminant function. Thus, the rank of each customer is determined at step 309(FIG. 7). This process will be described in detail with reference to FIG. 10.

It is assumed that there are five need types, “information need”, “support need”, “product checking need”, “service need”, and “human dependency need”, as shown in a need ranking table for customer A in FIG. 10. The need type shown in FIG. 8 corresponds to “human dependency need”, the need type shown in FIG. 19 corresponds to “product checking need”, and the need type shown in FIG. 20 corresponds to “information need.”

Customer A has registered himself/herself on the Web site of ABC Company. Factors that affect the above-mentioned needs are retrieved from data about customer A which is stored in the plurality of databases described earlier to identify the needs of customer A and his/her rank in the data set is determined (309, FIG. 7).

Ranks determined in this way are shown in the need ranking table for customer A shown at the top of FIG. 10. For example, information need of customer A is one hundred fifty thousandth in the total number of customers of one million two hundred thousand. The rank of each need is converted into percentage to the population parameter (the total number of customers) of the data set. The resultant percentage value is multiplied by a correction coefficient for customer A to calculate a need level, X′ (311, FIG. 7). The correction coefficient is set according to the property of each customer based on feedback resulting from the operation of this system. In the customer A's example, the correction coefficient for information need is set to 0.8, which is determined based on the results of transactions in the past showing that information has strong influence on customer A's purchasing decision. The need level is a rank or order in percent in the total number of customers, the smaller the value, the higher the need level.

The need level of each of the five need types calculated in this way is classified into five ranks or classes 1 to 5 based on a determination reference value as shown in FIG. 10 (313, FIG. 7). Examples of the determination reference values for individual needs are shown in a ranking table in FIG. 10. Rank 1 represents the most significant influence. The larger the rank value, the smaller the influence is.

Rank variables for customer A determined in this way are shown in the table at the bottom of FIG. 10 (315, FIG. 7).

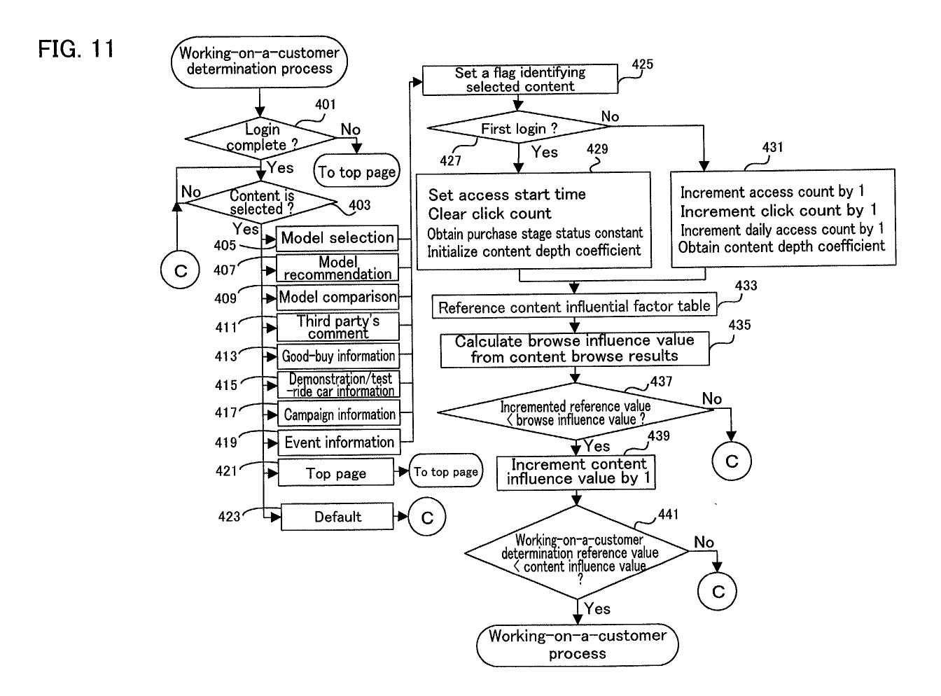

FIG. 11 shows a process flow for determining the timing of working-on-a-customer by ABC Company. When a customer completes a login to the Web page of ABC Company (401), a menu for selecting content appears on the customer's browser. The customer can select one of a plurality of contents (403), “Model selection” 405 through “Event information” 419. This menu page also contains an item for returning to the top page 421. When a content having substantial information is selected from the group of contents “Model selection” 405 through “Event information” 419, a flag indicating the selected content is set (425).

If this is the first time that the customer logs in to this Web page (427), the process proceeds to block 429, where access start time is set, click count is cleared, a purchase stage status constant is obtained, and a content depth coefficient is initialized. If this is not the first login, the process proceeds to block 431, where an access count, click count, and daily access count are incremented and the content depth coefficient is obtained.

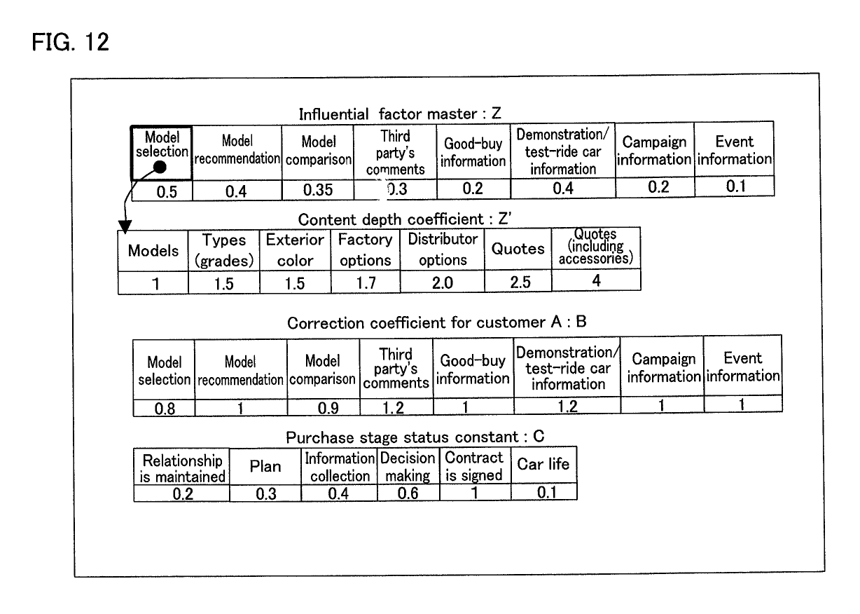

Now, influence of the content is calculated with reference to the table shown in FIG. 12. Value Z, which is stored in an influential coefficient master table, is assigned to each content category as shown in the table at the top of FIG. 12. For example, value Z for “Model selection” is 0.5 and that for “Model recommendation” is 0.4. Content depth coefficient Z′ indicates the depth of access in the hierarchical structure of the Web pages. In the category of “Model selection”, for example, the depth of the page for making car model selection is 1, the depth of the page for making type (grade) selection is 1.5, the depth of the page for selecting exterior colors is 1.5, and the depth of the page for requesting quotes is 2.5. Correction coefficient B for each customer is used for correcting the influential coefficient according to the character of the customer in consideration of the results of the operation of this system. Purchase stage status constant C indicates at which stage a customer is in the process of purchasing a car. For example, the purchase stage status constant of a customer at the stage of collecting information for purchasing a car is 0.4. Content influence M is defined by the following equation.

(Equation 1)

Content influence M=(Z×Z′)×B+C

Next, a browse influence value, which indicates the influence of a given content of ABC Company on car purchase by customer A, is calculated according to the following equation.

(Equation 2)

Browse influence value=(access count+daily access count+click count)×M

The browse influence value thus obtained for customer A is compared with an increment threshold (437). If it exceeds the reference value, the corresponding appropriate content influence value for the customer is incremented. For example, it is assumed that customer A proceeds from the “Model selection” (influential coefficient Z=0.5) menu in the chart in FIG. 12 to the quotes content having content depth Z′=2.5. Correction coefficient B for the model selection content for customer A is 0.8 as shown in a table in FIG. 12. If purchase stage status constant C for customer A is at an information collection stage (C=0.5), content influence M for customer A is 1.5 according to Equation 1.

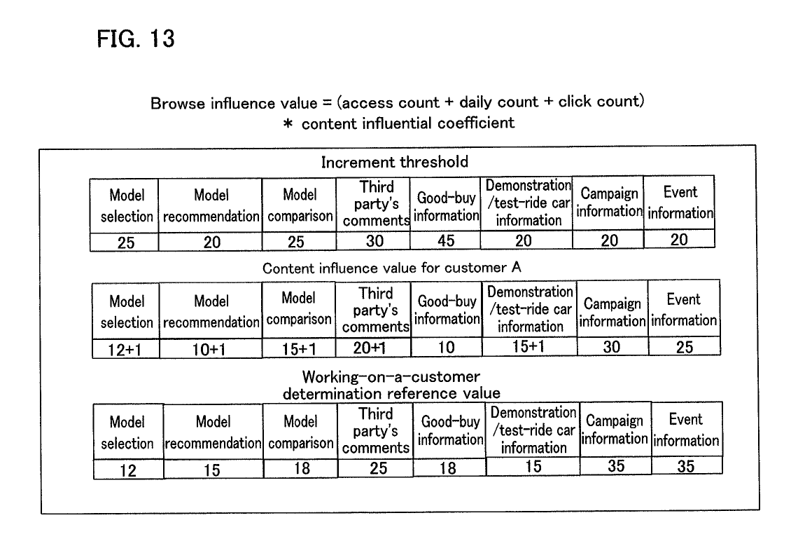

If access count+daily count+click count=18, the browse influence value for customer A is 27 according to Equation 2. As can be seen from the uppermost table in FIG. 8, the browse influence value of 27 is larger than the increment thresholds of 25 for model selection. Accordingly, the content influence values for the contents that are relevant to model selection, namely “model selection”, “model recommendation”, “model comparison”, “third party comments” and “demonstration/test-ride” are incremented with respect to customer A (439, FIG. 11). This is shown in the center table in FIG. 13.

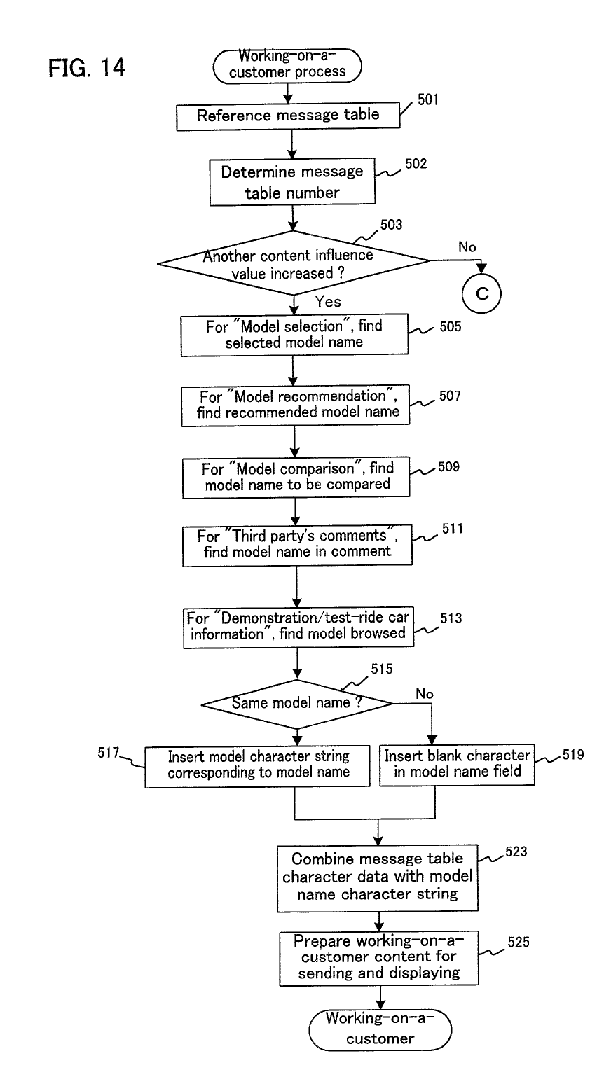

The content influence values thus updated for customer A are compared with reference or threshold values for determination of working-on-a-customer (441). Examples of the reference values are shown in a table at the bottom of FIG. 13. If the content influence value of any of the contents exceeds the corresponding reference value, a process for working on customer A from ABC Company is performed. In this example, the content influence value for the “model selection” content for customer A becomes 13, which exceeds the corresponding reference value of 12. The content influence value for the “demonstration/test-ride car information” is 16, which also exceed the corresponding reference value of 15. As a result, a working-on-a-customer process shown in FIG. 14 starts for customer A.

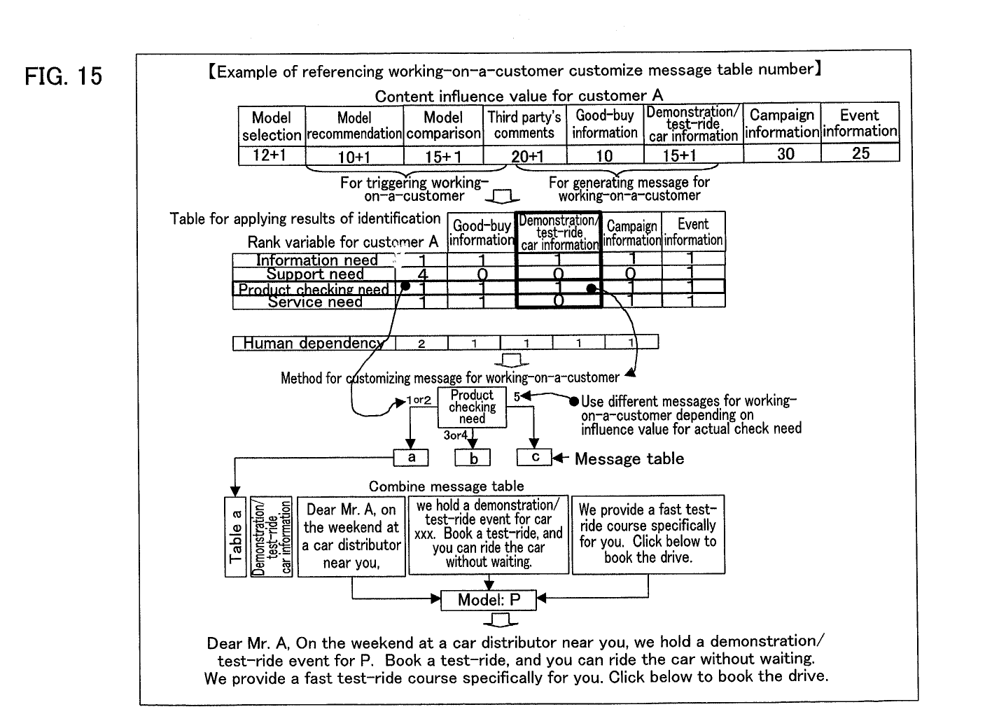

The process for working-on-a-customer from company A after the process shown in FIG. 13 will be described with reference to FIGS. 14 and 15. First, reference is made to content influence values for customer A at the top of FIG. 15. While the process will be described for customer A, who may be any given customer, processes similar to this are performed for all customers in the database. As shown in the table in FIG. 15, contents are classified into two groups, one being the group that triggers working-on-a-customer, and the other being the group that generates a message for working-on-a-customer. In the example of customer A, the working-on-a-customer process is started relative to customer A in response to the content influence value for the “model selection” content exceeding the reference value for initiating the working-on-a-customer process. In addition, the content influence value for the “demonstration/test-ride car information” has also exceeded a corresponding reference value. A process will be carried out to generate a message for providing demonstration/test-ride car information to customer A.

In this embodiment, the rank variables described with reference to FIG. 10 are used to construct a message for working-on-a-customer. When the message for working-on-a-customer is to be formed based on the influence value for the “demonstration/test-ride car information” content as shown in FIG. 15, relevant need types having significant rank variables such as “1” are “Information need”, “product checking need”, and “human dependency.” The table in the middle of FIG. 15 indicates the need types having the rank of “1” in the column of “demonstration/test-ride car information.”

In FIG. 15, with respect to the “product checking need”, the rank variable is “1”. The system in this embodiment is programmed to select a message table “a” responsive to rank “1” or “2” in the product checking need. This is shown in the middle to lower section of FIG. 15. That is, if the product checking need is 1 or 2, message table “a” is selected. If the product checking need is 3 or 4, message table “b”, is selected. If it is 5, message table “c” is selected.

Referring again to FIG. 14, a message table is thus determined (502). Whether influence values for any content other than the “demonstration/test-ride car information” content is increased is determined (503). If the influence value for the “model selection” content is increased, a model name selected by customer A is found from the Web activity history database 40 (FIG. 5) (505). Similarly, if the influence value for the “model recommendation” content is increased, a recommended model name is found from the Web activity history database 40 (507). If the influence value for “model comparison” content is increased, model names to be compared with each other are found from the Web activity history database 40 (509). If the influence value for the “third party's comments” content is increased, a model name in the comment information is found from the Web activity history database 40 (511). In addition, the demonstration/test-ride content browsed by customer A is retrieved from Web activity history database 40 to find a browsed model name (513).

If there is the same model name in the model names thus found, such model name is inserted into the message for working-on-a-customer created in the process shown in FIG. 15 (517). If no same model names are in the model names, a blank character is inserted in the model name field in the message for working-on-a-customer (519). An example of the message thus generated is shown at the bottom of FIG. 15. In this way, character data in the message table is combined with the model name (523) to complete a working-on-a-customer content (525).

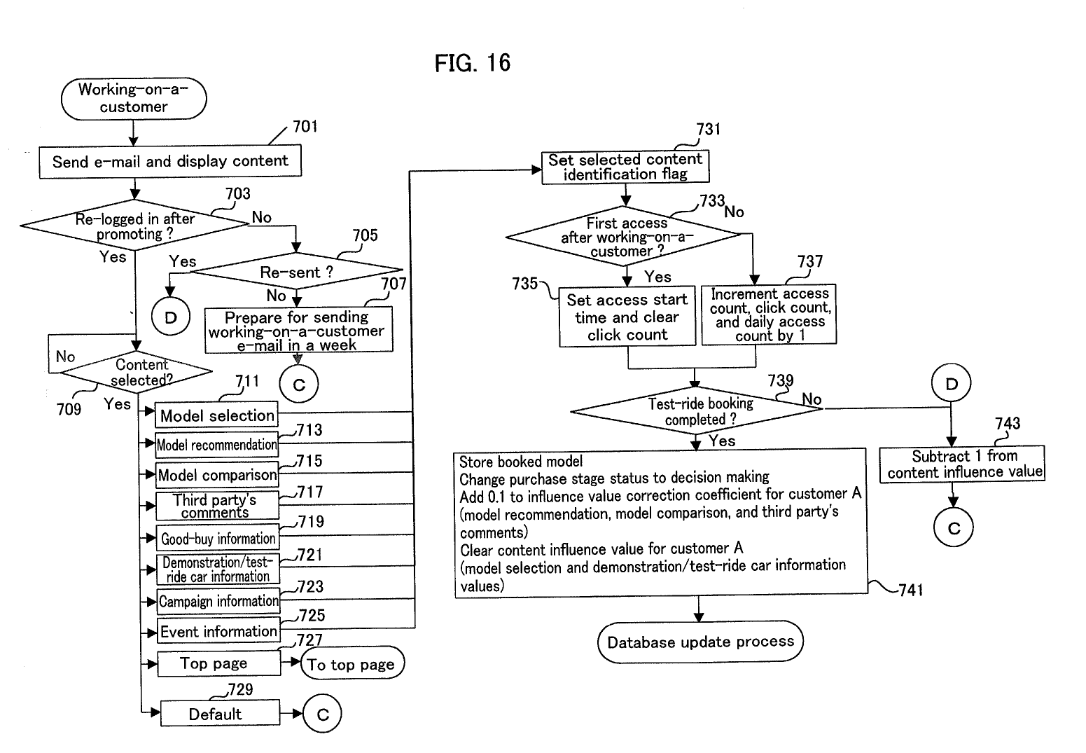

Referring to FIG. 16, the content thus completed is sent or notified to customer A in a manner described earlier with respect to FIG. 5 (701). This working-on-a-customer may take various forms, including contact by sales staff and direct male by ordinary male, as well as the form of Web site and e-mail.

If a customer to be worked on is decided in the process shown in FIG. 14, the customer comprehension engine 57 edits a content that matches the content influence values for the customer to be worked on according to directions from the customer comprehension engine 20 shown in FIG. 5. When the customer to be worked on subsequently logs into the Web page of ABC Company, a page edited for the customer will be presented to the customer. Company ABC can prompt the customer to access the page by notifying the customer that the special page is made available (701).

After working-on-a-customer to a customer is performed according to the system of the present invention, a response from the customer is detected and data in databases for the customer is modified to adjust the system so as to be able to prompt the customer more effectively in the future.

After the working-on-a-customer is performed, the activity history server 27 (FIG. 5) detects whether there is a login to the Web page by a customer to be worked on (703). If there is no login by the customer for a predetermined time period, for example two weeks, and working-on-a-customer has not been resent to the customer, sending of an inductive male to the customer in a week is scheduled (707). When the customer logs into the Web page after the working-on-a-customer, a message provided specifically for the particular customer is displayed on the menu page. On the menu page, a menu item for a content specifically edited is blinked or marked with a special symbol to attract the customer's attention.

In the example described with respect to customer A, the message for working-on-a-customer shown at the bottom of FIG. 15 appears on the browser. Demonstration/test-ride information 721 among the menu items shown in FIG. 16, Model selection 711 through Event information 725, is edited specifically for customer A and set so as to blink. When customer A selects one of the menu items and clicks it, a selected-content identification flag is set (731). If this is the first access after the working-on-a-customer (733), access start time is set and the click count is cleared (735). If this is the second or subsequent access, the access count, click count, and daily access count are incremented by 1 (737).

In this example, if a booking for a test-ride is made by customer A on the Web page (739), the booked model is first stored in the database, purchase stage status (in the database) is changed to the “decision making” stage, 0.1 is added to a correction coefficient for appropriate content influence value for customer A, and the content influence value is cleared for subsequent calculation. The test-ride booking may be performed by other means such as telephone or e-mail. In such a case, the sales staff or call center staff enters data about the test-ride booking into the system. If customer A makes no test-ride booking responsive to this working-on-a-customer, 1 is subtracted from the content influence value (743).

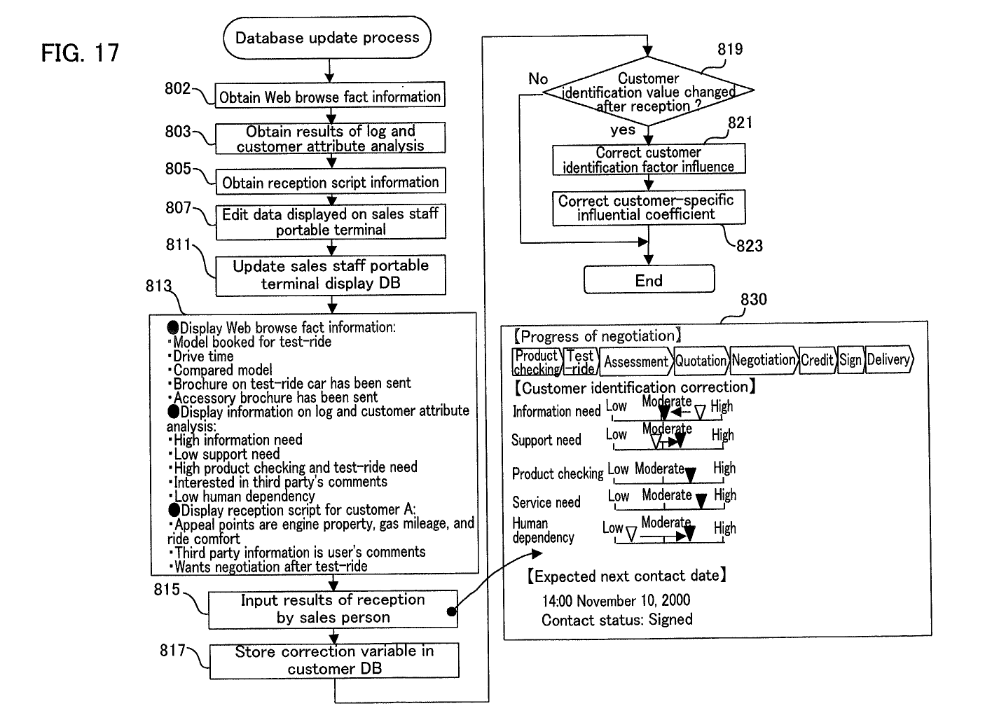

Then, a database update process in FIG. 17 is started. Fact information concerning Web browse by a customer of interest, customer A in this example, is retrieved from databases (802), the results of the analysis of the log and attributes of the customer are retrieved from the databases (803), reception script information is retrieved (805), data displayed on the portable terminals of the sales staff is edited (807), and database for providing information to portable terminals of the sales staff is updated (811).

Block 813 shows information displayed on a portable terminal of the sales staff or a terminal at a sales office after the above-described steps. The fact information from the Web site includes such information as model name of the car booked for test-ride, time booked for test-ride, models of cars compared by customer A, and information on delivery of a brochure of the model or a brochure of accessories.

Need information resulting from the analysis of the log and customer attributes of customer A includes information indicating that customer A has high information need, is interested in third party's comments, has low support need, high product checking and test-ride needs, and has low human dependency (dependency on the contact with the sales staff or other personnel).

The information to be displayed on a portable terminal of sales staff for reception of customer A includes information that would be of interest to customer A. Such information may include engine property, gas mileage, and riding comfort. It may also include information that third party comments that customer A is interested is comments of the users of the car. It may also include information that customer A would be interested in business discussion after test-ride.

After the sales person serves customer A's test-ride based on the above-mentioned information provided by the system, the sales person inputs the results of the test-ride as shown in block 830 (815). The sales person inputs information indicating in what stage the business discussion is. The stage may be selected from stages of product checking, test-ride, assessment, quotation, negotiation, credit application, sales done, and delivery. Based on the results of the service performed for customer A, the sales person modifies “information need”, “service support need”, “product checking need”, “service need”, and “human dependency” indicated by the system. The sales person also inputs the expected date on which he/she will contact customer A.

Correction variables based on the inputs by the sales person are stored in the customer database 30 (817, FIG. 17). The customer comprehension engine 20 determines whether any customer identification values are changed after servicing customer A (819), and if changed, corrects customer identification factor influence (821), and corrects customer-specific influence coefficients (823). In this way, the system is updated based on the results of the working-on-a-customer according to the calculations by the system, enabling more accurate calculations.

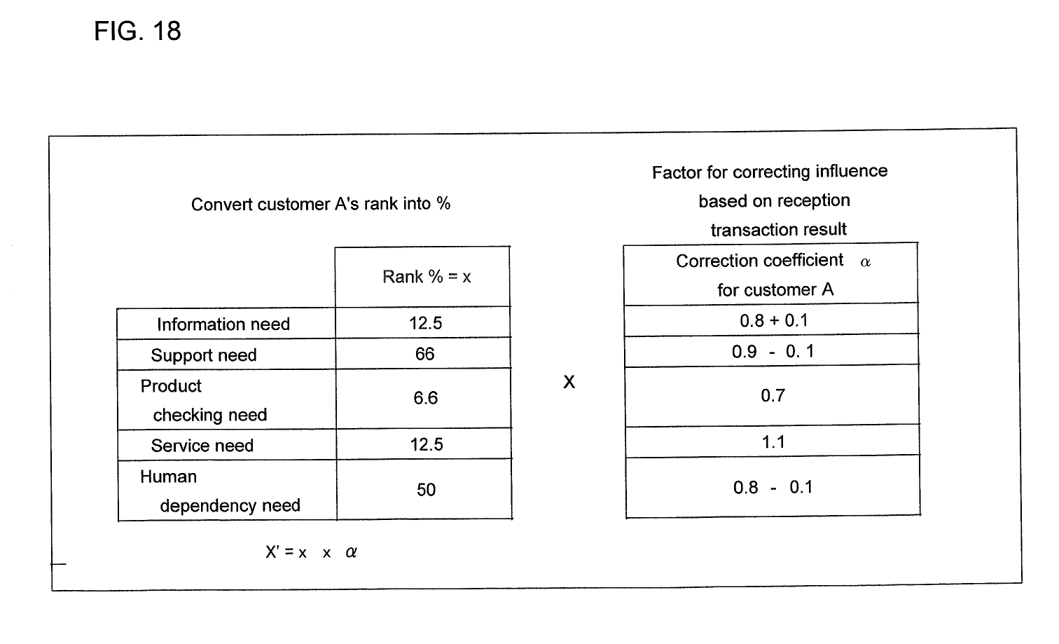

FIG. 18 shows a particular example of corrections at steps at 821 and 823 in FIG. 17. Correction coefficients for customer A's needs are modified based on the results of the reception of customer A shown in block 830 in FIG. 17 as entered by the sales person. For example, the information need of customer A, which stands in a position indicated by a white triangle in block 830 according to a calculation by the customer comprehension engine, is moved by the sales person to a position indicated by the black triangle. Based on this, the customer comprehension engine reduces influence of the information need relative to customer A. That is, as shown in FIG. 13, the engine increases the percentage ranking of customer A (a higher number indicates a lower rank from the top). In the example shown, the correction coefficient of the information need is corrected from 0.8 to 0.9. Similarly, the correction coefficient for influence of support need, product checking need, service need, and human dependency for customer A is modified based on the results shown in block 830 in FIG. 17. Corrected influence X′ of each of the needs can be expressed as:

X′=(rank %)X×(correction coefficient)α.

While the present invention has been described with respect to specific embodiments, the present invention is not limited to the embodiments.

What is claimed is:

1. A computer system for generating customer-specific car charts and providing pages of the customer-specific car charts on a Web site on the Internet, comprising:
a data editor for editing data about individual customers to generate the car charts based on data transferred from electronic control units mounted in the cars of the customers and data obtained when sales are done; and
a car chart database for storing the edited customer-specific car charts,
wherein the computer system generates car chart pages personalized for individual customers.

2. The computer system according to claim 1, further comprising a customer comprehension engine for determining need property of the customer based on factors relating to the customer, wherein the customer comprehension engine is programmed to output a signal for prompting an action of working-on-a-customer based on information contained in the car chart database.

3. The computer system according to claim 2, wherein, when the car chart indicates that the customer's car requires some sort of service including a repair service and a maintenance service, the customer comprehension engine selects a working-on-a-customer content for the customer according to the service need property of the customer.

4. The computer system according to claim 1, wherein said data editor edits car charts for sales stores

5. The computer system according to claim 1, wherein the data in the electronic control unit is transferred from the car to a terminal device at a service shop by wireless transmission or through a memory card

6. Method for generating customer-specific car charts and providing pages of the customer-specific car charts on a Web site on the Internet, comprising:
editing data about individual customers to generate the car charts for the individual customers based on data transferred from electronic control units mounted in the cars of the individual customers and data entered based on the information generated when sales are done;
storing the edited customer-specific car charts in a car chart database; and
generating pages of the customer-specific car charts personalized for individual customers.

7. The method according to claim 6, further comprising;
determining the need property of an customer based on factors relating to the customer;
generating a signal for prompting an action of working-on-a-customer based the determined need property and data on the customer contained in the car chart database.

8. The method according to claim 7, further comprising, when the car chart indicates that the customer's car requires a repair or maintenance service, selecting a working-on-a-customer content for the customer according to the service need property of the customer.

9. The method according to claim 6, further comprising editing car charts for sales stores

10. The method according to claim 6, further comprising, transferring data in the electronic control unit from the car to a terminal device at a service shop by wireless transmission or through a memory card.
